(19) United States
(12) Patent Application Publication
(10) Pub. No.: US 2009/0238109 A1
(43) Pub. Date: Sep. 24, 2009

(54) METHOD FOR QUALIFIED ROUTE BUILDING IN A WIRELESS NETWORK

(75) Inventors: Robert P. Byard, Sandy, UT (US); Stephen R. Thurber, Orem, UT (US); Damon M. Stewart, Provo, UT (US); Helaman D. Pratt Ferguson, Lindon, UT (US); John P. Filoso, Pleasant Grove, UT (US); Paul E. Millett, Orem, UT (US); Hugh C. Nielsen, Provo, UT (US)

Correspondence Address: SCHWEGMAN, LUNDBERG & WOESSNER, P.A., P.O. BOX 2938, MINNEAPOLIS, MN, 55402, US

(73) Assignee: Digi International Inc., Minnetonka, MN (US)

(21) Appl. No.: 12/050,487

(22) Filed: Mar. 18, 2008

(51) Int. Cl. H04Q 7/00

(52) U.S. Cl. 370/328

(57) ABSTRACT

A method of establishing a qualified route in a mesh network includes transmitting a route-discovery request from a source node such that transmitting includes transmitting the route-discovery request from the source node to at least one intermediate node that is a neighbor node to the source node, receiving the route-discovery request from an intermediate node at the destination node, and updating a route-discovery table for the intermediate node such that the route between the source node and the destination node is the only qualified route.

### TECHNICAL FIELD

Mesh networking creates routing table and neighbor table entries in nodes that may be on a route that has been established during a route discovery process.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Mesh networking requires the construction of packet routes that can be dynamic depending upon the participation of newcomer nodes as well as the departure of removed nodes or failed nodes. An Ad-Hoc Distance Vector (ADOV) algorithm can create routing table (RT) and neighbor table (NT) entries in nodes that do not lie on an optimum route that is selected during a route-discovery process. These spurious RT and NT entries may displace useful RT and NT entries. Further, these spurious RT and NT entries can propagate, leading to the creation of corresponding spurious RT and NT entries in adjacent nodes. This leads to unnecessary route discovery, route congestion and increased latency in the mesh network.

### BRIEF DESCRIPTION OF THE DRAWINGS

FIG. 1a illustrates a method flow of a mesh network during building a qualified route for transmitting a data packet between a source node and a destination node according to an example embodiment;

FIG. 1b illustrates further route building after achieving the status depicted in FIG. 1a according to an example embodiment;

FIG. 1c illustrates further route building depicted in FIG. 1b according to an example embodiment;

FIG. 1d illustrates further route building depicted in FIG. 1c according to an example embodiment;

FIG. 1e illustrates further route building depicted in FIG. 1d according to an example embodiment;

FIG. 1f illustrates an alternate qualified route that is established in the mesh network according to an example embodiment;

FIG. 2a illustrates an example of routing for a data packet between a source node and a destination node in a mesh network according to an example embodiment;

FIG. 2b illustrates a disruption in the mesh network depicted in FIG. 2a according to an example embodiment;

FIG. 2c illustrates repaired routing for the data packet in the disrupted mesh network depicted in FIG. 2b according to an example embodiment;

FIG. 3 is a flow diagram for a method of transmitting a data packet from a given node according to an example embodiment;

FIG. 4 is a is a flow diagram for handling a received data packet according to an example embodiment;

FIG. 5 is a method flow diagram for qualifying routing for a data packet in a mesh network according to an example embodiment;

FIG. 6 is a flow diagram 600 that describes a handler method for network data by two levels of acknowledgement according to an example embodiment;

FIG. 7 is a flow diagram 700 that describes efforts of an intermediate node that is assisting in route discovery according to an example embodiment;

FIG. 8 is a flow diagram 800 that describes efforts of an intermediate node that is assisting in route reply according to an example embodiment;

FIG. 9 is a schematic diagram illustrating a medium having an instruction set that locates a qualified route in a mesh network between a source node and a destination node according to an example embodiment; and

FIG. 10 represents a route-discovery table with a series of route-discovery entries lodged therein.

### DETAILED DESCRIPTION

In the following detailed description of example embodiments, reference is made to specific example embodiments by way of drawings and illustrations. These examples are described in sufficient detail to enable those skilled in the art to practice the delineated embodiments, and serve to illustrate how the embodiments may be applied to various purposes. Features or limitations of various embodiments described herein, however useful to the example embodiments in which they are incorporated, do not limit other embodiments, and any reference to the disclosed embodiments, their elements, operation, and application do not limit the embodiments but serve only to define these example embodiments.

As noted above, in AODV, a route request is broadcast from the source node and rebroadcast until it reaches the destination node. All nodes receiving the route request build a route discovery table. The route discovery table exists for the duration of the route discovery process. Nodes receiving subsequent route requests which represent an improved path back to the source node update their route discovery table, and rebroadcast their request. The destination node unicasts a route response message back towards the source node by way of the node which relayed the route request. If the destination node subsequently receives one or more route requests which represent an improved path to the source node, the destination node once again unicasts route response messages. When the route discovery process is over, nodes build routing and neighbor table entries from the data in the route discovery table.

We have found that route discovery (RD) in mesh networks can be performed more efficiently. In one embodiment, this is done by shortening the route discovery process timeout for the source node, while leaving all other nodes using the same, longer timeout interval. When the source node times out, it sends the data packet which instigated the route discovery. The passage of this qualifying data packet through the selected route causes the route discovery tables to mark their table entries as “qualified”. When their route discovery process times out, each node with a qualified table entry builds or updates routing and neighbor table entries. Nodes with table entries that have not been “qualified” do not build or update their routing and neighbor table entries. Such an approach avoids the creation of spurious table entries, with all their associated problems.

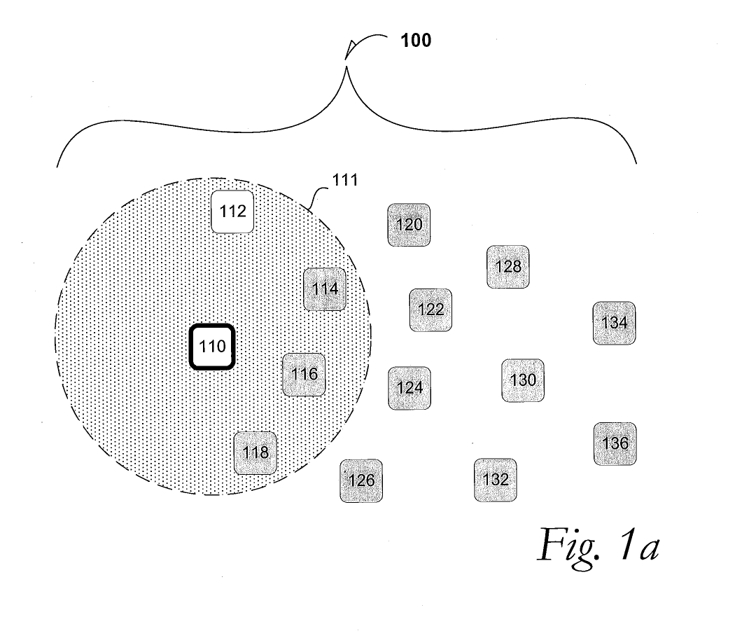

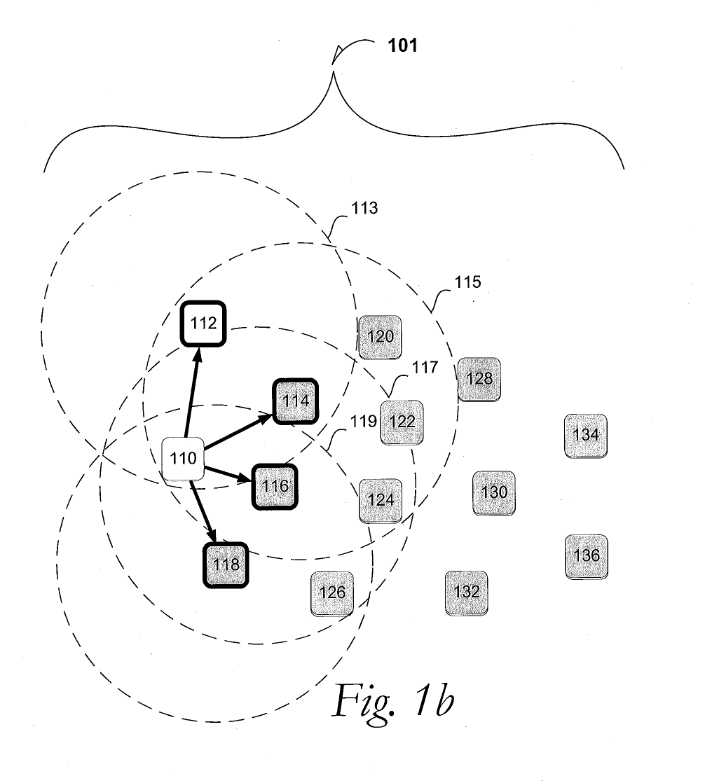

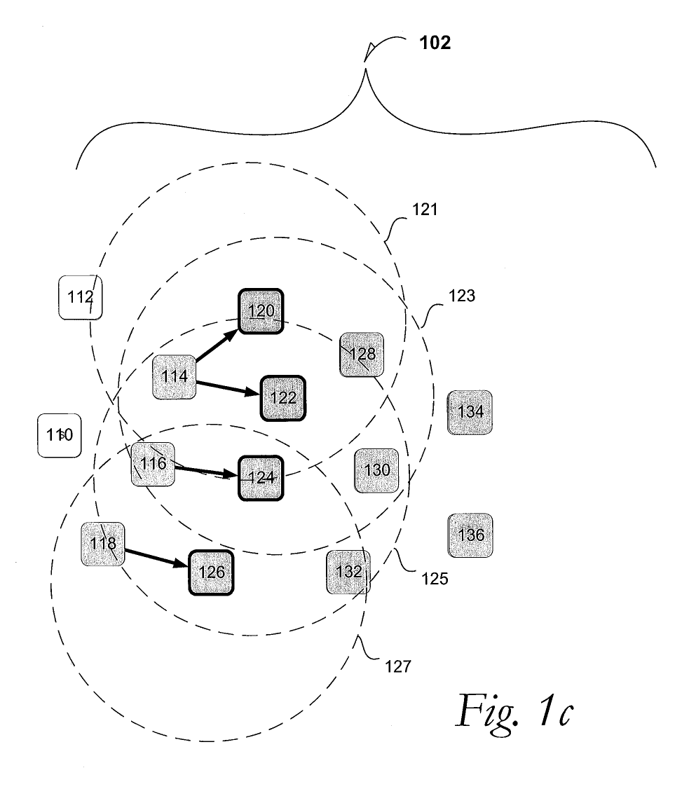

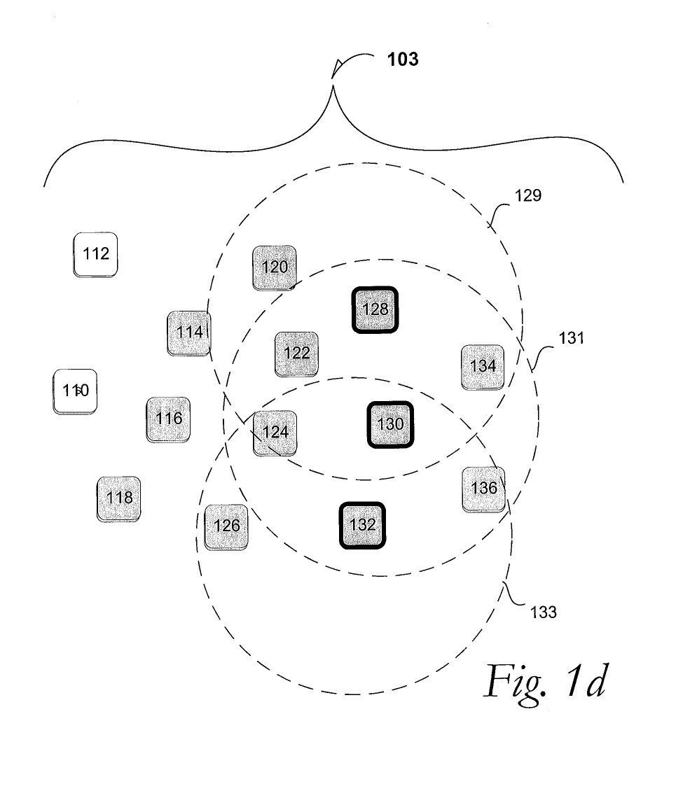

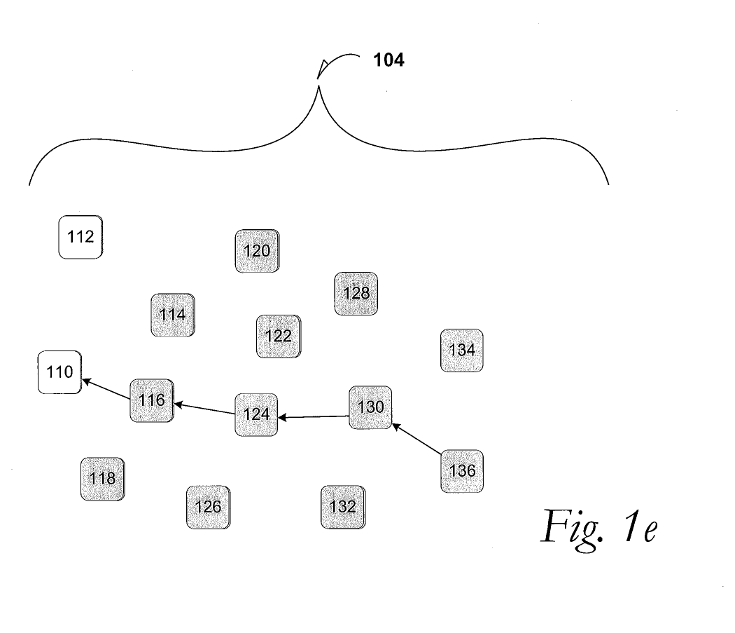

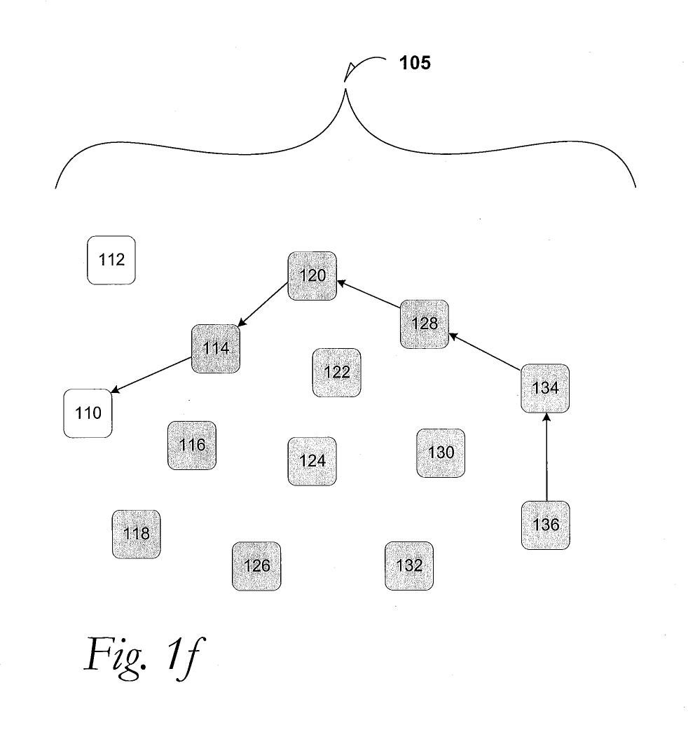

FIG. 1a illustrates a method flow of a mesh network 100 during building a qualified route for transmitting a data packet between a source node 110 and a destination node 136 according to an example embodiment. The source node 110 is prepared to send a data packet to the destination node 136, but a route is to be selected. The mesh network 100 includes a plurality of potential intermediate nodes 112, 114, 116, 118, 120, 122, 124, 126, 128, 130, 132, and 134. A qualified route is to be chosen through the mesh network 100 between the source node 110 and the destination node 136. The source node 110 may be part of a subnetwork (subnet) that is depicted as the mesh network 100 according to an embodiment.

During the method flow embodiment, the source node 110 creates a broadcast area 111 that emanates from the source node 110. During the illustrated stage of the method embodiment, the source node 110 is in broadcast mode and is depicted with a heavier outline that other nodes. According to an embodiment, at least one intermediate node may be within the broadcast area 111.

A route-request packet (RREQ) is broadcast from the source node 110. The broadcast area 111 from the source node 110 is depicted as finding the intermediate nodes 112, 114, 116, and 118. Consequently, as illustrated, the intermediate nodes 112, 114, 116, and 118 have been located as neighbor nodes to the source node 110. The source node 110 builds a neighbor table (NT) that includes all the neighbor nodes that are detected within the broadcast area 111 and that do not have any closer intermediate nodes to the source node 110.

The source node 110 builds a neighbor table (NT) that includes all neighbors within the broadcast area 111 which are best accessed according to link quality without the use of intermediate relay nodes. The source node 110 also builds a routing table (RT) which lists pairs of destination and neighbor nodes, where a message intended for a given destination node will be relayed through its paired neighbor node.

A source node 110 which does not have a destination node 136 appearing in its neighbor table (NT) or routing table (RT) will launch a route discovery process. During route discovery a route-discovery table (RDT) is created by each node in the network for the duration of the process. A route discovery table (RDT) entry includes quality metrics for the route between the source node 110 and an intermediate node (112, 114, 116, 118), as well as between an intermediate node and the destination node 136. One quality metric is signal strength between neighboring nodes. Another is the hop count between the source node and the node which hosts the RDT. Another is the number of attempts needed to convey a message between the host node and a neighboring node. Other quality metrics may be included in a formula to estimate the quality of a route between the nodes, which is recorded and updated in the RDT.

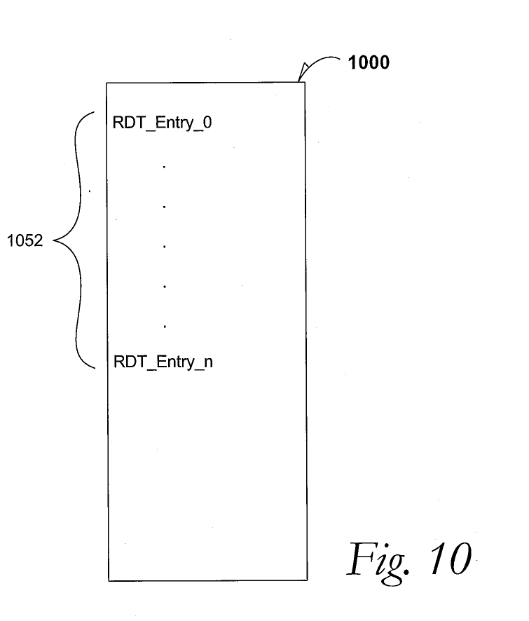

A route-discovery table (RDT) may be used to lodge several sequential route-discovery attempts as is illustrate in FIG. 10. The RDT 1000 includes a plurality of entries 1052. In one embodiment, each entry 1052 includes information detailing a route discovery in process. In one such embodiment, each entry 1052 includes the information detailed in the following C-language structure, as will be described below. A text description for each field appears after the structure.

```
struct UTRDT_t{
  uint8 type;
  caddr_t Source;
  caddr_t Sndr;
  caddr_t Dest;
  caddr_t Succ;
  uint8 SeqN;
  uint8 RetryCount;
  uint8 Qualified;
  uint8 LRU;
  uint16 RevQual;
  uint16 FwdQual;
  uint8 RevHops;
  uint8 FwdHops;
};
```

type—marks entry as empty or active.
Source—address of node that launched the RREQ
Sndr—address of node that relayed the RREQ to this node
Dest—address of destination node.
RD seeks a route between Source and Dest.
Succ—address of successor node, neighbor of this node that should be used to relay a message to the destination.
SeqN—sequence number of the route discovery. Combined with the Source address, uniquely identifies this RD among all others that may be occurring at the same time.
RetryCount—iteration count for the RD process. Route Discovery may be attempted more than once before abandoning establishing a route between a source node and a destination node.
Qualified—boolean value. Initialized as false when RD entry is allocated. Set true when the qualifying data packet traverses the route. When RD ends, only those nodes with a qualified RD entry build NT and RT entries. The embodiment of a qualified route and using that qualification as a criterion for building routing entries is different from the conventional AODV algorithm.
LRU—vestigial data field.
RevQual—reverse quality, cumulative metric for route quality from the Destination to this node.
FwdQual—forward quality, cumulative metric for route quality from the source node to this node.
RevHops—number of relays between this node and the destination node.
FwdHops—number of relays between the Source and this node.

The source code embodiment may operate in one of several layers. An application layer (APP) may include the data packets. A network layer (NWK) may include a mesh network such as XMesh. A medium-access control (MAC) layer may include a standard such as IEEE 802.15.4, established and periodically updated by the WPAN™ Task Group 4 known in industry. The physical layer (PHY) may be frequent-hopping spread-spectrum (FHSS) radio communication.

The NWK and MAC layers are used to estimate route quality as a function of the quality of its component links. The quality of a link between two nodes may be determined as a function of the following factors: link count; the signal strength in each link; the fullness of the NT and/or RT tables.

The terminology LQ_Rssi is defined as returning zero for received strength signal indication (RSSI) better than −60 dB; 1 if <=−75 dB; 2 if <−80 dB, a rising function from 3 to 22 for the range between −80 and −95 dB, and 27 for >−95 dB.

In an embodiment when selecting a route, a route with the minimal metric value is selected over other routes. The selection metric may select routes with few, but strong (in RSSI) hops. Thus a slightly longer (in hops) route composed of stronger links may be selected before a short route with weaker links. Weak links fail more often and require more MAC Layer retries to convey a data packet. The metric weighs against nodes that have an almost full neighbor table; a sign the node may be becoming a bottleneck for many routes, that may adversely affect at least one of latency, congestion, and effective bandwidth.

In an embodiment MAC layer retries are not used as a component of link quality because they may not be as constant a metric as the others. A link with a 10% probability of conveying a packet that returns a snapshot retry metric of one retry 10% of the time, may mislead the route-discovery process into calculating the link is useful when it in practice is not. Route discovery that takes the time to estimate the probability of success of a link with, for example, 10 or 20 tries may take much longer, and may congest the wireless mesh network in the process. Using a moving time average of MAC Layer retries may not respond adequately to sudden changes in the environment, such as a door opening or closing, or a vehicle moving to obstruct the route of the link between two neighbor nodes.

FIG. 1b illustrates further route building after achieving the status depicted in FIG. 1a according to an example embodiment. The mesh network 101 is depicted including the source node 110 and the identified neighbor nodes 112, 114, 116, and 118. The arrows depict possible routes between the source node 110 and the neighbor nodes 112, 114, 116, and 118, each as a possible qualified route portion that is being sought to reach the destination node 136. The intermediate nodes 112, 114, 116, and 118 are depicted as creating respective broadcast areas 113, 115, 117, and 119. The intermediate nodes 112, 114, 116, and 118 are also depicted in heavier outline to indicate broadcast mode.

Several RREQs are broadcast from the intermediate nodes 112, 114, 116, and 118. The several broadcast areas 113, 115, 117, and 119 may impinge upon neighbor nodes 120, 122, 124, and 126. The intermediate node 112 is depicted as finding no neighbor nodes in response to the route-discovery request (RREQ) from the source node 110. Consequently, the intermediate node 112 may be disqualified from further activity related to the specific RREQ between the source node 110 and the destination node 136.

Where more than one node is in a broadcast-to-neighbor mode, the respective broadcast areas may detect the same single node. For example as illustrated, the intermediate nodes 114 and 116 each detect the neighbor nodes 120, 122, and 124.

Each broadcast node builds a respective NT and a respective RT. For example, the intermediate node 114 builds an NT that includes the neighbor nodes 120, 122, and 124. Similarly as the source node 110 has accomplished, each intermediate broadcast node RDT includes quality metrics between the broadcasting node and each neighbor node.

FIG. 1c illustrates further route building depicted in FIG. 1b according to an example embodiment. The mesh network 102 is depicted including the source node 110 and its identified neighbor nodes 112, 114, 116, and 118. The mesh network 102 also depicts the intermediate nodes 114, 116, and 118 as having identified their neighbor nodes 120, 122, 124, and 126.

Broadcasting RREQs are depicted emanating from the intermediate nodes 120, 122, 124, and 126. The intermediate nodes 120, 122, 124, and 126 are depicted as creating respective broadcast areas 121, 123, 125, and 127. The intermediate nodes 120, 122, 124, and 126 are also depicted in heavier outline to indicate broadcast mode.

The broadcast areas 121, 123, 125, and 127 may impinge upon neighbor nodes 128, 130, and 132. Where more than one node is in a broadcast-to-neighbor mode, the respective broadcast areas may detect the same single node. For example as illustrated, the intermediate nodes 122 and 124 each detect the intermediate nodes 128 and 130.

Each broadcast node builds a respective NT. For example, the intermediate node 124 builds a neighbor table that includes the neighbor nodes 128, 130, and 132. Similarly as the source node 110 has accomplished, each intermediate broadcast node also builds a respective RDT to monitor quality metrics between the broadcasting node and each neighbor node.

FIG. 1d illustrates further route building depicted in FIG. 1c according to an example embodiment. The mesh network 103 is depicted including the source node 110 and its identified neighbor nodes 112, 114, 116, and 118. The mesh network 103 also depicts the intermediate nodes 114, 116, and 118 as having identified their neighbor nodes 120, 122, 124, and 126. The mesh network 103 also depicts the intermediate nodes 120, 122, 124, and 126 as having identified their neighbor nodes 128, 130, and 132.

Several broadcasting RREQs are depicted emanating from the intermediate nodes 128, 130, and 132. The intermediate nodes 128, 130, and 132 are depicted as creating respective broadcast areas 129, 131, and 133. The intermediate nodes 128, 130, and 132 are also depicted in heavier outline to indicate broadcast mode.

The broadcast areas 129, 131, and 133 may impinge upon neighbor nodes 134 and 136; the neighbor node 136 being the destination node 136.

Each broadcast node builds a respective NT. For example, the intermediate node 130 builds a neighbor table that includes the neighbor nodes 134 and 136. Similarly as the source node 110 has accomplished, each intermediate broadcast node builds a respective RDT that includes quality metrics between the broadcasting node and each neighbor node.

FIG. 1e illustrates further route building depicted in FIG. 1d according to an example embodiment. The mesh network 104 has now achieved transmitting the several RREQs that originated from the source node 110 to the destination node 136 by several node-to-node pathways. The destination node 136 unicasts a route-reply packet (RREP) back along the route defined by an immediately previous hop of a RREQ. For example, the destination node 136 unicasts an RREP to the intermediate node 130. The RREP is selected to go to the intermediate node 130 instead of the intermediate node 132 for any number of quality reasons that may reside in the RT for the destination node 136. In an embodiment, each intermediate node that is a neighbor node to the destination node 136 may have conveyed link quality to the destination node. Consequently in the illustrated embodiment, the destination node 136 had unicast the RREP exclusively to the intermediate node 130. In an embodiment, the unicast RREP may go out toward all nodes in the broadcast area such that the respective neighbor nodes may update their RDTs.

As illustrated in FIG. 1e, the intermediate node 130 has directed the RREP to the intermediate node 124, and the intermediate node 124 has further directed the RREP to the intermediate node 116. Finally, the RREP has been directed from the intermediate node 116 to the source node 110.

At this juncture according to a method embodiment, a data packet is sent back up along the route just established from the source node 110, sequentially through the intermediate nodes 116, 124, and 130, and ultimately to the destination node 136. As the data packet arrives at each sequential intermediate node, a message of “qualified” is electronically stamped on each intermediate node RT. Consequently, the source node 110 sequentially certifies the intermediate nodes 116, 124, and 130. And finally, the route to the destination node 136 is piecemeal certified as a qualified route. As the data packet is received at the destination node 136, the destination node 136 generated a acknowledgement of packet (ACK) that is returned to the source node 110.

The disclosed embodiments shorten the route-discovery process timeout for the source node 110. This method embodiment leaves all intermediate nodes for a given RREQ using the same but a longer timeout interval than that of the source node. Consequently, once the source node 110 has sent the requested data packet, it times out after a first time interval. The intermediate nodes time out, however, after a second time interval that is greater (longer) than the first time interval.

The passage of a qualifying data packet through the route that has been established causes the several route-discovery tables to mark their table entries as “qualified”. When the route discovery process times out for each intermediate node that is certified as qualified, each node builds or updates their respective RT and NT entries from the information in the RDT entry which is expiring and a qualified route is established.

Intermediate nodes that are not certified as qualified do not build or update their respective RT and NT entries. This non-qualified metric results in avoiding spurious or “outlier” table entries. Consequently, subsequent route discoveries from the non-qualified intermediate nodes are avoided. This also means congestion during a RREQ may be avoided, as well as latency.

FIG. 1f illustrates an alternate qualified route that is established in the mesh network 105 according to an example embodiment. As illustrated in FIG. 1f, the intermediate node 134 has directed the RREP to the intermediate node 128, the intermediate node 128 has directed the RREP to the intermediate node 120, and the intermediate node 120 has further directed the RREP to the intermediate node 114. Finally, the RREP has been directed from the intermediate node 114 to the source node 110.

By a comparison of FIG. 1e and FIG. 1f, different routes may be selected depending upon overall quality metrics that are established during route discovery and that may be lodged in the several RTs. For example, although the RREP route depicted in FIG. 1f may appear to be geographically longer than the RREP route depicted in FIG. 1e, the overall quality for the RREP route in FIG. 1f may be more useful. Further, dynamic changes may occur that could cause a given RREP route to become less favorable than another RREP route that was previously established, but that may have achieved only runner-up status as the most useful RREP route.

In an embodiment, a geographically shortest route may be selected as a certified RREP route. In an embodiment, a time-dependent RREP route that is the shortest in expended time may be selected. In an embodiment although a shorter expended time may be established for a given RREP route, some RREP routes may not have the same overall link quality on the outbound segment for the RREQ as for the return segment for the RREP.

In an embodiment, the destination node 136 may receive multiple RREQs. Consequently, the destination node 136 may respond with one RREP for each unique RREQ.

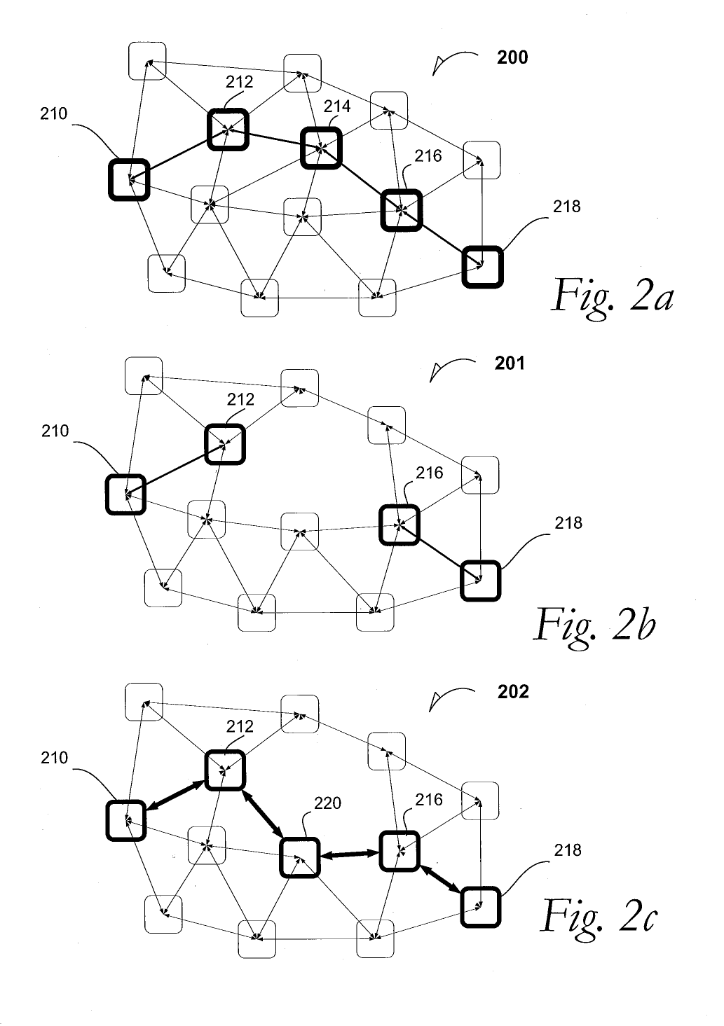

FIG. 2a. illustrates an example of routing for a data packet between a source node 210 and a destination node 218 in a mesh network 200 according to an example embodiment. A source node 210 and a destination node 218 are linked for a given RREP data packet through the intermediate nodes 212, 214, and 216. The route through the intermediate nodes 212, 214, and 216 is serially marked in each respective RT as exclusively qualified for the given route. Consequently, only RTs in the intermediate nodes 212, 214 and 216 are certified as qualified in order to establish only one qualified route.

FIG. 2b illustrates a disruption in the mesh network depicted in FIG. 2a according to an example embodiment. The mesh network 201 shows a missing intermediate node 214 (FIG. 2a) such that the qualified route has been disrupted.

FIG. 2c illustrates repaired routing for the data packet in the disrupted mesh network depicted in FIG. 2b according to an example embodiment. According to an embodiment, when a disruption has been detected, routing for an RREQ and an RREP may be reestablished by the source node 210 initiating a new RREQ or also by the destination node 218. In this embodiment, the several NTs and RTs have data from a previous route-discovery process iteration. Consequently, a new qualified route may be established that uses the intermediate node 220. In this embodiment, all previously qualified intermediate nodes 212 and 216 that were not lost are used in the new qualified route. In an embodiment, a new qualified route may be established that uses less than two of the previously qualified intermediate nodes. In an embodiment, an entirely new qualified route may be established that uses none of the previously qualified intermediate nodes.

As illustrated in FIGS. 2a, 2b, and 2c, the method of updating RDTs may be limited only to those RDTs that are along the qualified route. Where a link in the qualified route may be lost, however, route discovery may be continued with vestigial entries in RDTs that were not in qualified nodes along the route. Consequently as depicted in FIG. 2c, route repair may be accomplished by noting the location of the lost node, and examining the RDTs of neighbor nodes of the lost node.

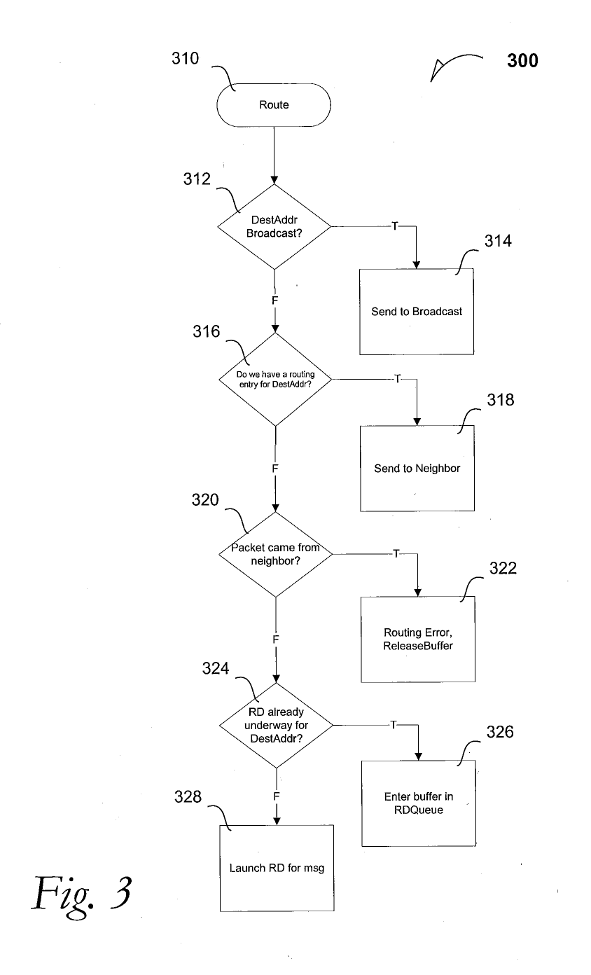

FIG. 3 is a flow diagram for a method of transmitting a data packet from a given node according to an example embodiment. The flow diagram 300 is a decision tree for deciding whether a data packet needs to go somewhere from a given node.

At 310, a route is presumed. At 312, a query is made whether a destination address (DestAddr) is being broadcast. If true at 312, the node sends the information by broadcasting at 314.

At 316 if conditions for the query at 312 are not met, a query is generated whether a routing entry exists for the DestAddr. A lookup is carried out in the NT for the given node. If the DestAddr is lodged in the NT, the data packet is routed directly to the DestAddr node as depicted at 318. Otherwise, if the DestAddr is lodged in the RT, the data packet is routed directly to the neighbor node paired with the DestAddr node as depicted at 318.

If a routing entry is not present in the RT for this node as depicted at 320, a query is executed at 324 whether this data packet came from a neighbor node. If conditions for this query are true, a routing error has occurred, and the data packet is released at a release buffer as depicted at 322.

If conditions for this query are false such that the data packet did not come from a neighbor node, a query is generated whether a RREQ was already under way for this DestAddr as depicted at 324. At 326 if conditions for this query at 324 are true, the data packet is entered into the route discovery queue for this RREQ. If at 328, however, conditions for this query at 324 are false, the data packet likely came from outside through a uniform resource (UR) port and a RREQ is launched for the message. Consequently, the given node at which this query is being handled becomes a source node for a RREQ.

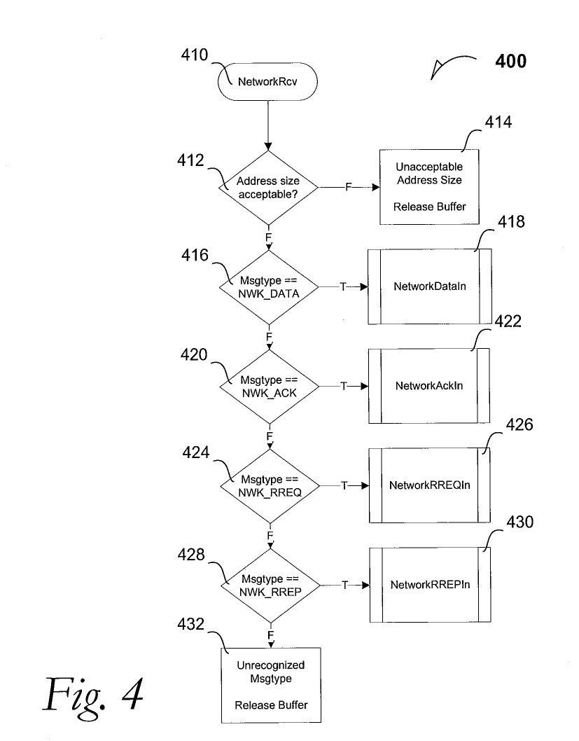

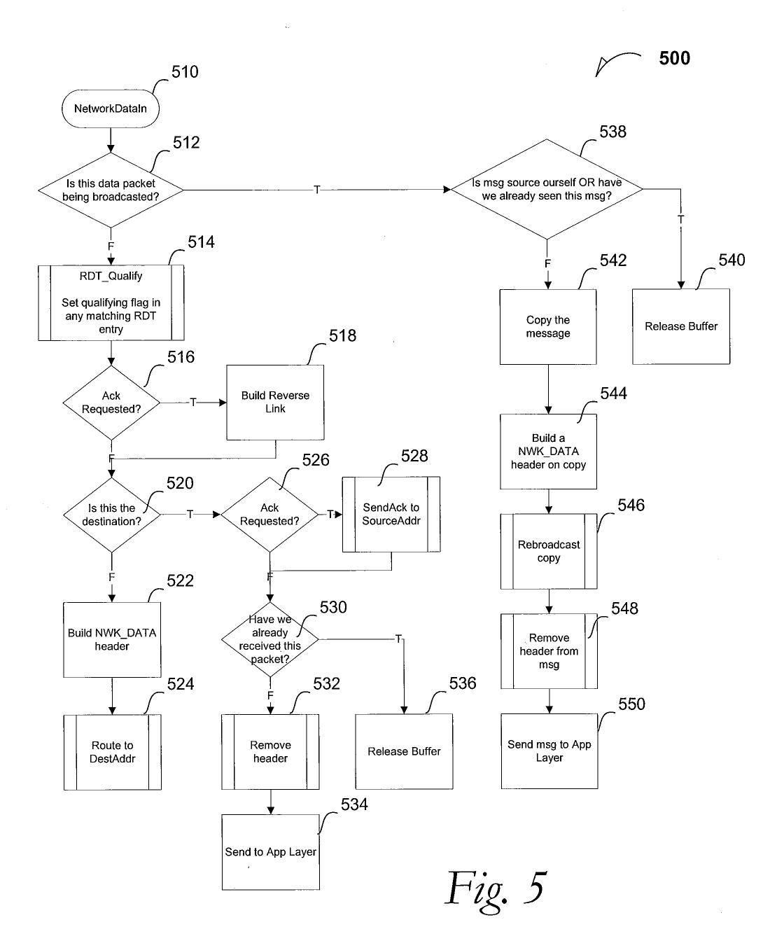

FIG. 4 is a is a flow diagram 400 for handling a received data packet according to an example embodiment. At 410 a network receive action is acknowledged such that a data packet has arrived at a node. In an embodiment, this is a wireless communication received at a given node.

At 412, a query is executed whether the address size for the data packet of an acceptable size. This means the query tests the data packet to see if it belongs in this mesh network. Where conditions for this query are false, it is determined that the data packet has an unacceptable address size, and the data packet is dumped at a release buffer at 414.

Where the data packet has an acceptable address size, several further tests may be carried out. The specific order depicted in FIG. 4 may be followed but any other order after the query at 412 may also be followed.

At 416, a query is executed whether the message type (Msgtype) is network data (NWK_DATA). When conditions for this query are true, the data packet is sent to a Network Data In (NetworkDataIn) handler at 418.

At 420, a query is executed whether the Msgtype is a network acknowledgement (NWK ACK) such as being sent from a destination node that the data packet was received. When conditions for this query are true, the data packet is sent to a Network Acknowledged In (NetworkAckIn) handler at 422.

At 424, a query is executed whether the Msgtype is a network route request (NWK_RREQ) such as having been originated from a source node. When conditions for this query are true, the data packet is sent to a Network Route Request In (NetworkRREQIn) handler at 426.

At 428, a query is executed whether the Msgtype is a network route reply (NWK_RREP) such that the route request has been sent from a destination node. When conditions for this query are true, the data packet is sent to a Network Route Reply In (NetworkRREPIn) handler at 430.

In an embodiment, other queries may be handled that meet specific applications.

At 432 if none of the queries meet true conditions, an unrecognized Msgtype is presumed and the data packet is dumped at a release buffer.

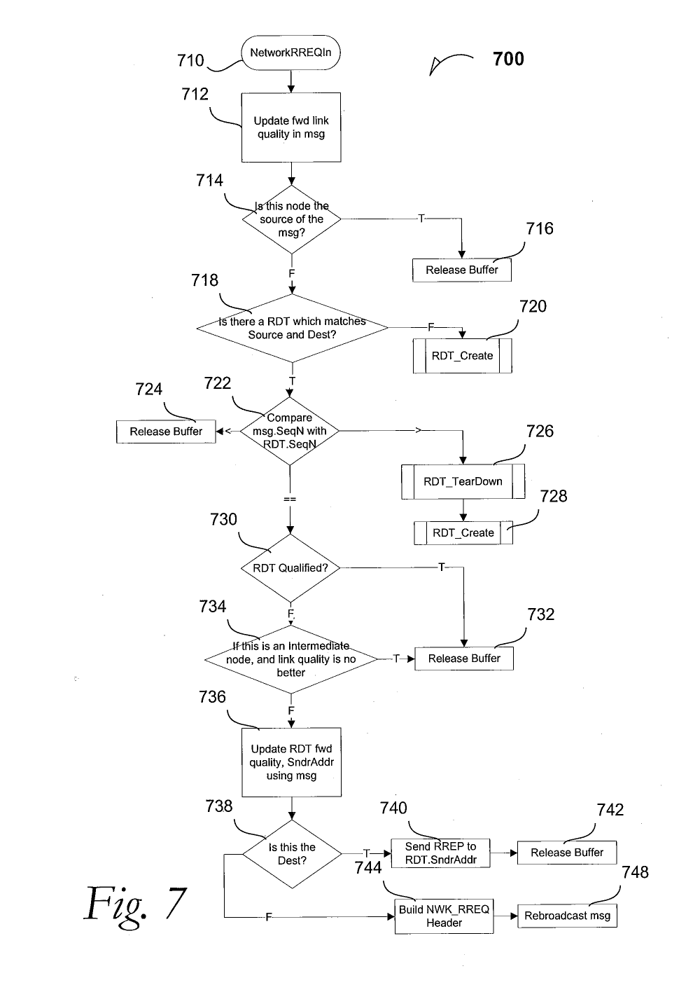

FIG. 5 is a flow diagram 500 that describes a handler method for network data according to an example embodiment. At 510, network data is detected appearing in the network at a given node.

At 512, a query is executed whether the data packet is being broadcasted. When conditions for this query are false, a “qualified” certificate (RDT_Qualify) is lodged in the route-discovery table (RDT) for that node. Consequently at 514, a qualifying flag is set unless there exists a previous qualifying flag in the RDT. In other words when route discovery ends, routing tables have built RDTs with the RDT_Qualify certificate such that only the route that actually gets used builds respective RDTs in the nodes along the route. This reduces significant burdens on the entire mesh network as only a fraction of the mesh network builds the needed RDTs. Consequently, routing tables are not being built globally throughout the mesh network that may otherwise dislodge more useful entries in the various nodes.

At 516, a query is executed whether an acknowledgement has been requested for this data packet. Where conditions for this query are true, a reverse link is built to the node from whence the data packet was received as indicated at 518. Where conditions for an acknowledgement have not been requested, another query at 520 is executed to determine whether the node is the destination node.

At 522 where conditions are determined that the given node is not the destination node, a NWK-DATA header is written to the data packet and the data packet is routed toward the DestAddr representing the destination node as depicted at 524.

Where the query at 520 to determine whether the node is the destination node is true, a query is executed whether a ACK is requested as indicated at 526. Where true, a send ACK (SendAck) message is directed toward the address of the source node. Where no ACK is requested as indicated at 526, a query is executed at 530 to determine whether this data packet has already been received at this node. Where this data packet has already been received at this node, the data packet is dumped into a release buffer as indicated at 536.

Because the decision tree at 530 already has established the given node is the destination node, and the query at 530 indicates this data packet has not already been received at this node, the header is removed at 532 and the data packet is “sent up” to the application layer as depicted at 534.

At 538 when conditions for the query executed at 512 are true, a second query is executed whether the given node has already seen the given data packet. This is because redundancy may be avoided if the given node has already seen the given data packet. Consequently, where conditions for the redundancy query are true, the data packet is dumped in a release buffer at 540.

At 542 when conditions for the query executed at 538 are false, a copy of the data packet is made at 542 and a NWK_DATA header is affixed to the data packet at 544. At 546, the copy is rebroadcast with the NWK_DATA header.

At 548 when the data packet has reached a destination node, the NWK_DATA header is removed and the data packet is “sent up” to an application layer as represent at 550.

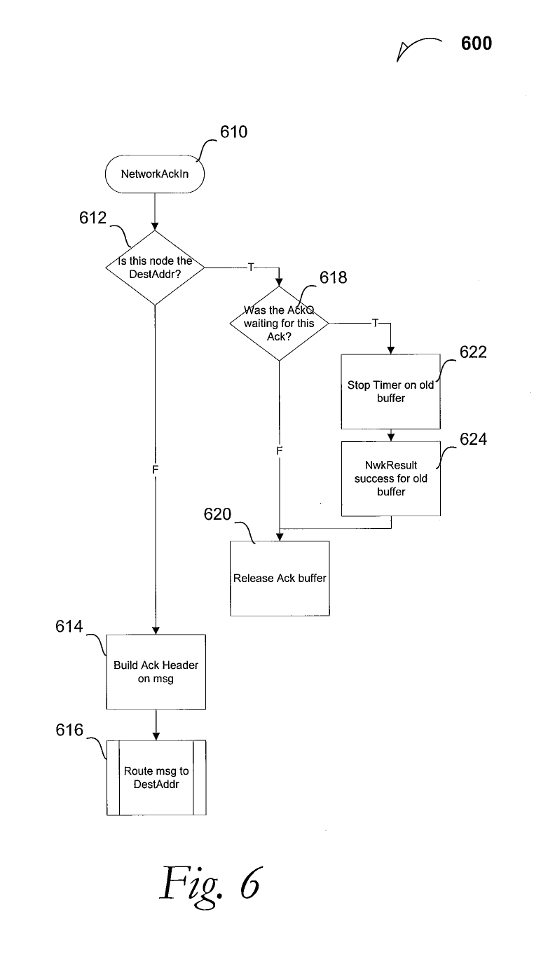

FIG. 6 is a flow diagram 600 that describes a handler method for network data by two levels of acknowledgement according to an example embodiment. One level of acknowledgement is at a MAC layer between two adjacent nodes in a mesh network. Another level of acknowledgement is at the network layer that is across a route of links or multiple hops.

At 610, network data is detected coming into the network. At 612, a query is executed, whether this node is the destination node, meaning the DestAddr node. Where the conditions of the query are false, the method includes building an ACK header on the data packet at 614 and further routing the data packet toward the destination address or destination node as depicted at 616.

At 618, the method executes a query whether the acknowledgement request (AckQ) was waiting for this specific acknowledgement. When the conditions are false, the AckQ is discarded at a release buffer depicted at 620. Where the conditions are true, meaning the AckQ was waiting for this specific ACK, the timer on the old buffer is stopped as depicted at 622 and the network result (NwkResult) is demarcated successful for the old buffer as indicated as depicted at 624. This means the AckQ may repeat several times up to a time-out number of iterations in an attempt to establish the ACK as requested.

FIG. 7 is a flow diagram 700 that describes efforts of an intermediate node that is assisting in route discovery according to an example embodiment. At 710, Network Route Request In (NetworkRREQIn) event is detected. Upon detection of the NetworkRREQIn event, the forward link quality is updated in the message as depicted at 712. The forward link quality has to do with the number of node hops and MAC retry events among other things.

Because this flow method is for an intermediate node, at 714 a query is executed to be certain the source of the message is not this node. Where the given node is indeed the source of the message, the NetworkRREQIn event is discarded in a release buffer at 716.

AT 718, the method includes executing a query whether this node contains an RDT that matches the source and destination. Where the query returns a false, a route-discovery table create (RDTCreate) action is carried out that generates an RDT for the node as depicted at 720.

Where the query returns a true that there is an RDT with the source and destination addresses lodged in the given node, a query is generated at 722 to compare the sequence numbers (SeqN) to detect multiple route discovery attempts. The various SeqNs track which iteration of route discovery is being done for this source and destination pair in the RDT. If the SeqN is and older iteration, the SeqN is dropped and discarded at a release buffer at 724. If the SeqN is a newer iteration, the RDT is torn down as depicted at 726 and a new RDT is generated as depicted at 728.

It is possible for an intermediate node to get the same RREQ from the source node but by multiple routes. Consequently, if the SeqN is equal to the previous number of route-discover attempts, a query is generated at 730 to determine if the RTD is already qualified. Where the conditions are true, the RREQ is discarded at a release buffer as depicted at 732. This is done because the RREQ from the source node has already arrived at this node but by a different path.

In a method embodiment, link quality is updated from among the duplicate RREQs. At 732, a query is executed, since this is at an intermediate node, whether the link-quality metric for this latest RREQ is worse than or equal to the previous RREQ. When the condition is true, this RREQ is discarded at the release buffer as depicted at 732. When the condition is false, meaning this RREQ in fact has a more useful link quality, then the RDT is updated with the most recent RREQ due to the improved link quality as depicted at 736. Consequently, a more useful route back to the source node has been found.

Finally since the method flow depicted in FIG. 7 is used for intermediate nodes, a query is executed whether this node is the destination node. When the condition is true, a RREP is generated that is sent back to the neighbor node that relayed the RREQ to this node as depicted at 740. Thereafter, the RREQ is discarded at a buffer as depicted at 742.

Where the node is not the destination node as depicted as the false condition at 738, a network RREQ (NWK_RREQ) header is assigned to the data packet and the message is rebroadcast as depicted at 748 to assist in finding the destination node through this given node if possible.

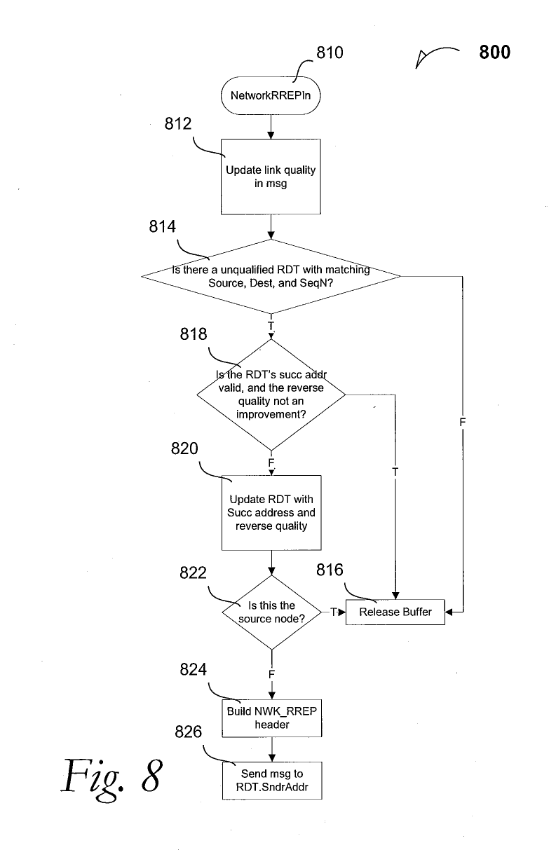

FIG. 8 is a flow diagram 800 that describes efforts of an intermediate node that is assisting in route reply according to an example embodiment. Because route replies are unicast back toward the source node, any given node may receive multiple duplicate RREPs.

At 810 a RREP is detected at the given node. Initially, the link quality in the message is updated as depicted at 812.

At 814, a query is executed whether this node includes an unqualified RDT with a matching source address, destination address, and sequence number. Where the condition is false, the message is discarded at a release buffer depicted at 816. Where the condition is true, a query is generated at 818 whether the RDT successor address is valid and whether the reverse-route direction quality is not an improvement. When the conditions are true, then the message is also discarded at the release buffer depicted at 816.

Where the query depicted at 818 returns a false condition, meaning the RDT successor address is valid and the reverse-route direction quality is in fact an improvement, then the RDT is updated with this successor address and the reverse-route quality is also updated as depicted at 820.

This method allows for dealing with asymmetrical quality phenomena such as the route on the way from source-to-destination may be better than the exact same route on the way back from destination-to-source, or vice versa. This method embodiment therefore keeps track of the reverse quality as well as the forward quality. Consequently, the quality of a given route takes both directions into consideration, which compensates for any possible asymmetry in the observed route quality which depends on which direction one traverses the route.

At 822, a query is generated whether this given node is the source node. This would mean the RREQ had found the route completely from destination node back to the source node. Where the query condition is true, the message is discarded at a release buffer depicted at 816. Where the query condition is false, meaning the source node has not yet been reached, a network route reply (NWK_RREP) header is built on the RREP as depicted at 824 and the message is sent further along the route as depicted at 826.

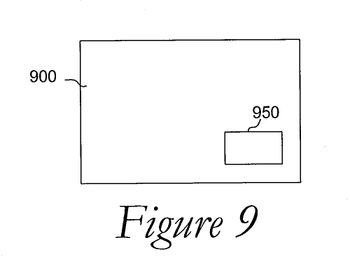

FIG. 9 is a schematic diagram illustrating a medium having an instruction set that locates a qualified route in a mesh network between a source node and a destination node according to an example embodiment. A machine-readable medium 900 includes any type of medium such as a link to the Internet or other network, or a disk drive or a solid state memory device, or the like. A machine-readable medium 900 includes instructions within an instruction set 950. The instruction set 950, when executed by a machine such as an information handling system or a processor, cause the machine to perform operations that include locating a qualified route in a mesh network between a source node and a destination node.

In an example embodiment of a machine-readable medium 900 that includes the instruction set 950, the instructions, when executed by a machine, cause the machine to perform operations modifying the link-quality metric in a URRP.

Thus, methods and a machine-readable medium including instructions for locating a qualified route for a data packet have been described. Although the various methods for locating a qualified route in a mesh network between a source node and a destination node have been described with reference to specific example embodiments, it will be evident that various modifications and changes may be made to these embodiments without departing from the broader embodiment of the disclosed subject matter. Accordingly, the specification and drawings are to be regarded in an illustrative rather than a restrictive sense.

Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that the disclosed embodiments be limited only by the claims, and the full scope of equivalents thereof.

We claim:

1. A method for packet route discovery comprising:
transmitting a request (RREQ) from a source node in a mesh network for reception at a destination node in the mesh network, wherein transmitting includes transmitting the RREQ from the source node to at least one intermediate node that is a neighbor node to the source node;
at each intermediate node, generating a route discovery table;
receiving the RREQ from an intermediate node at the destination node; updating the route-discovery table for the intermediate node as a function of the response from the destination node;
establishing a qualified route between the source node, at least one intermediate node, and the destination node, wherein the at least one intermediate node is certified as qualified by passage of the data packet; and
transmitting the data packet from the source node along the qualified route.

2. The method of claim 1, after transmitting the data packet from the source node, the method further including:
first timing out the source node after a first time interval and after transmitting the data packet; and
subsequent timing out each qualified node and destination node after a second time interval, wherein the second time interval is greater than the first time interval.

3. The method of claim 2, wherein after at least one time-out cycle for an intermediate node in the plurality of intermediate nodes, where no packet is received, marking the route discovery table in the intermediate node as unqualified.

4. The method of claim 1, further including updating the route discovery table at an intermediate node when a packet route improvement is recorded.

5. The method of claim 1, after transmitting the packet to an intermediate node in the plurality of intermediate nodes, marking the route discovery table in the intermediate node as qualified.

6. The method of claim 1, after losing a node in the qualified route the method further including:
repairing the qualified route by qualifying a new intermediate node along with all previously qualified nodes.

7. The method of claim 1, after losing a node in the qualified route the method further including:
repairing the qualified route by qualifying at least two new intermediate nodes along with at least one previously qualified node.

8. The method of claim 1, after losing a node in the qualified route the method further including:
repairing the qualified route by qualifying all new intermediate nodes and none of the previously qualified nodes.

9. The method of claim 1, wherein a data packet at a given node is processed by one method selected from broadcasting a route-discovery request and transmitting a packet to a neighbor node.

10. The method of claim 1, wherein a received data packet is tested for acceptable address size; whether the message type is network data; whether the message type is a network acknowledgement; whether the message type is a route-discovery request; and whether the message type is a route reply.

11. The method of claim 1, wherein a received data packet is tested whether the data packet is being broadcasted:
when the data packet is being broadcasted, the method includes building a reverse link in response to an acknowledgement request; and
when the data packet is not being broadcasted, the method includes copying a message in the data packet and transmitting the message to an application layer.

12. The method of claim 1, the method further including:
waiting for an acknowledgement request (AckQ) at the source node;
when the AckQ is received, stopping a timer and beginning a first timeout delay; and
when the AckQ is not received after selected iterations, timing out the AckQ.

13. The method of claim 1, wherein duplicate RREQs arrive at an intermediate node, the method further including updating link quality from among the duplicate RREQs.

14. The method of claim 1, before transmitting the data packet the method further including:
comparing the qualified route from the source node to the destination node to a potential route from the destination node to the source node; and
canceling the qualified route and selecting the potential route from the destination node to the source node.

15. A method comprising:
broadcasting a route-discovery request between a source node and a destination node, wherein a plurality of intermediate nodes are disposed between the source node and the destination node;
establishing a qualified route between the source node and the destination node;
transmitting a data packet from the source node;
first timing out the source node after a first time interval; and
second timing out each intermediate node after a second time interval that is longer than the first time interval.

16. The method of claim 15, wherein after at least one time-out cycle for an intermediate node in the plurality of intermediate nodes, where no packet is received, marking the route discovery table in the intermediate node as unqualified.

17. The method of claim 15, further including updating the route discovery table at an intermediate node when a packet route improvement is recorded.

18. The method of claim 15, after transmitting the packet to an intermediate node in the plurality of intermediate nodes, marking the route discovery table in the intermediate node as qualified.

19. The method of claim 15, wherein a received data packet is tested for acceptable address size; whether the message type is network data; whether the message type is a network acknowledgement; whether the message type is a route-discovery request; and whether the message type is a route reply.

20. The method of claim 15, wherein a received data packet is tested whether the data packet is being broadcasted:
when the data packet is being broadcasted, the method includes building a reverse link in response to an acknowledgement request; and
when the data packet is not being broadcasted, the method includes copying a message in the data packet and transmitting the message to an application layer.

21. The method of claim 15, the method further including:
waiting for an acknowledgement request (AckQ) at the source node;
when the AckQ is received, stopping a timer and beginning a first timeout delay; and
when the AckQ is not received after selected iterations, timing out the AckQ.

22. The method of claim 15, wherein duplicate RREQs arrive at an intermediate node, the method further including updating link quality from among the duplicate RREQs.

23. The method of claim 15, before transmitting the data packet the method further including:
comparing the qualified route from the source node to the destination node to a potential route from the destination node to the source node; and
canceling the qualified route and selecting the potential route from the destination node to the source node.

24. A data structure encoded on a machine-readable medium, comprising:
a command queue operable to receive instructions from an external computerized system, the command queue operable to store commands that are operable when executed to weight a link-quality metric between receipt of a broadcast route request packet and a unicast route reply packet in a mesh network; and
wherein the machine-readable medium comprises an instruction to decrease the link-quality metric by a factor that is based upon a state of a routing table within a device in the mesh network.
